(19) United States
(12) Patent Application Publication
(10) Pub. No.: US 2016/0134575 A1
(43) Pub. Date: May 12, 2016

(54) System and Method of Providing Social Networking Web Site

(71) Applicant: Szu-Yu Lin, New Taipei City (TW)

(72) Inventor: Szu-Yu Lin, New Taipei City (TW)

(21) Appl. No.: 14/534,242

(22) Filed: Nov. 6, 2014

(51) Int. Cl. H04L 12/58; G06Q 50/00

(52) U.S. Cl. CPC H04L 51/32; G06Q 50/01

(57) ABSTRACT

A method of providing a social networking website includes steps as follows. A user profile associated with the parent ID is acquired from a member database when a parent ID is logged in the social networking website, where the user profile includes a plurality of personal basic data, the personal basic data at least includes a child age. A first age range based on the child age is set. When the child age associated with the parent ID and another child age associated with another parent ID fall within the first age range, or when the gestational age associated with the parent ID and another child age associated with said another parent ID fall within the second age range, said another parent ID is served as a recommended parent ID, and information on the recommended parent ID is provided for the parent ID.

### BACKGROUND

1. Field of Invention

The present invention relates to social networks. More particularly, the present invention relates to social networking websites.

2. Description of Related Art

A social networking service is a platform to build social networks or social relations among people who share interests, activities, backgrounds or real-life connections. A social network service consists of a representation of each user (often a profile), his or her social links, and a variety of additional services. Social networks are web-based services that allow individuals to create a public profile, to create a list of users with whom to share connections, and view and cross the connections within the system.

Most social network services are web-based and provide means for users to interact over the Internet, such as e-mail and instant messaging. Social network sites are varied and they incorporate new information and communication tools such as mobile connectivity, photo/video/sharing and blogging. Online community services are sometimes considered as a social network service, though in a broader sense, social network service usually means an individual-centered service whereas online community services are group-centered. Social networking sites allow users to share ideas, pictures, posts, activities, events, and interests with people in their network. However, the conventional social networking service does not focus on parents having similar background (e.g., similar child age) with an international community.

In view of the foregoing, there exist problems and disadvantages in the related art for further improvement; however, those skilled in the art sought vainly for a suitable solution. In order to solve or circumvent above problems and disadvantages, there is an urgent need in the related field to provide social networking websites for parents.

### SUMMARY

The following presents a simplified summary of the disclosure in order to provide a basic understanding to the reader. This summary is not an extensive overview of the disclosure and it does not identify key/critical components of the present invention or delineate the scope of the present invention. Its sole purpose is to present some concepts disclosed herein in a simplified form as a prelude to the more detailed description that is presented later.

In one aspect, the present disclosure provides a system and a method of providing a social networking website for parents, so as to solve or circumvent aforesaid problems and disadvantages.

According to one embodiment of the present disclosure, the system of providing the social networking website includes a network device, a member database, a processor and a memory. The memory is coupled to the processor and configured for storing instructions, which, when executed by the processor, performs operations including the following steps of: receiving a parent identification (ID) through the network device; acquiring a user profile associated with the parent ID from the member database when the parent ID is logged in the social networking website, wherein the user profile includes a plurality of personal basic data, the personal basic data at least includes a child age or a gestational age; determining a first age range based on the child age or a second age range based on the gestational age; when the child age associated with the parent ID and another child age associated with another parent ID both fall within the first age range, or when the gestational age associated with the parent ID and another child age associated with said another parent ID both fall within the second age range, serving said another parent ID as a recommended parent ID, and providing information on the recommended parent ID for the parent ID.

In one embodiment, the information on the recommended parent ID is shown in an electronic map of the social networking website.

In one embodiment, the personal basic data further comprises a resident region and a user defined language.

In one embodiment, the social networking website provides an automatic translation according to the user defined language.

In one embodiment, the operations further includes a step of searching the member database for the recommended parent ID based on the personal basic data.

In one embodiment, the social networking website provides a recommended itinerary for a family tour based on the user defined language and the child age.

In one embodiment, the recommended itinerary is shown in an electronic map.

In one embodiment, the information on the recommended parent ID is provided when a search keyword received through the network device appears in a posted article of the recommended parent ID.

In one embodiment, the information on the recommended parent ID is provided when a posted article of the parent ID and another posted article of the recommended parent ID are partially matched.

In one embodiment, the social networking website provides a plurality of networking groups shown in an electronic map, and when one of the networking groups is selected by the parent ID, the recommended parent ID is chosen form the one of the networking groups.

In another embodiment, the method of providing the social networking website includes steps as follows. A parent ID is received through a network device. A user profile associated with the parent ID is acquired from a member database when the parent ID is logged in the social networking website, where the user profile includes a plurality of personal basic data, the personal basic data at least includes a child age or a gestational age. A first age range based on the child age or a second age range based on the gestational age is set. When the child age associated with the parent ID and another child age associated with another parent ID both fall within the first age range, or when the gestational age associated with the parent ID and another child age associated with said another parent ID both fall within the second age range, said another parent ID is served as a recommended parent ID, and information on a recommended parent ID is provided for the parent ID.

Many of the attendant features will be more readily appreciated, as the same becomes better understood by reference to the following detailed description considered in connection with the accompanying drawings.

### BRIEF DESCRIPTION OF THE DRAWINGS

The present description will be better understood from the following detailed description read in light of the accompanying drawing, wherein:

FIG. 1 is a block diagram of a system of providing a social networking website according to one embodiment of the present disclosure; and

FIG. 2 is a flowchart of a method of providing the social networking website according to another embodiment of the present disclosure.

### DETAILED DESCRIPTION

In the following detailed description, for purposes of explanation, numerous specific details are set forth in order to attain a thorough understanding of the disclosed embodiments. In accordance with common practice, like reference numerals and designations in the various drawings are used to indicate like elements/parts. Moreover, well-known elements or method steps are schematically shown or omitted in order to simplify the drawing and to avoid unnecessary limitation to the claimed invention.

In the detailed embodiment and the claims, unless otherwise indicated, the article “a” or “the” refers to one or more than one of the word modified by the article “a” or “the.”

Through the present specification and the annexed claims, the description involving the “electrical connection” refers to the cases where one component is electrically connected to another component indirectly via other component(s), or one component is electrically connected to another component directly without any other component.

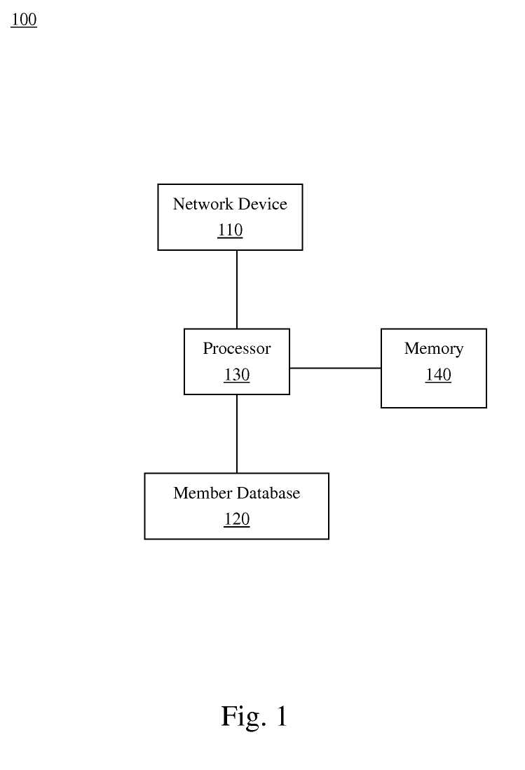

FIG. 1 is a block diagram of a system 100 of providing a social networking website according to one embodiment of the present disclosure. As illustrated in FIG. 1, the system 100 comprises a network device 110, a member database 120, a processor 130 and a memory 140. In structure, the network device 110, the member database 120 and the memory 140 are electrically connected to the processor 130. For example, system 100 can be one or more servers, workstations and/or computers, the network device 110 can be an Ethernet card or a wireless network card, the processor 130 can be a central processor, microcontroller or the like, the memory 140 can be an integrated circuit of any type which is adapted to store digital data or any other storage component (such as, ROM, RAM, etc.) and the member database 120 can be stored in different storage devices or in a single storage device, such as a computer hard drive, server, or any other recording medium.

During operation, a user can register a parent ID and then uses the parent ID to log in the social networking website of the system 100. In the system 100, the memory 140 is coupled to the processor 130 and configured for storing instructions, which, when executed by the processor 130, performs operations including the following steps of: receiving a parent ID through the network device 110; acquiring a user profile associated with the parent ID from the member database 120 when the parent ID is logged in the social networking website, where the user profile includes a plurality of personal basic data, the personal basic data at least includes a child age or a gestational age; determining a first age range based on the child age or a second age range based on the gestational age; searching the member database 110 for a recommended parent ID based on the personal basic data; when the child age associated with the parent ID and another child age associated with another parent ID both fall within the first age range, or when the gestational age associated with the parent ID and another child age associated with said another parent ID both fall within the second age range, serving said another parent ID as a recommended parent ID, and providing information on the recommended parent ID for the parent ID, where the child age associated with the parent ID and another child age associated with the recommended parent ID both fall within the first age range, or the gestational age associated with the parent ID and another child age associated with the recommended parent ID both fall within the second age range. For example, the child age associated with the parent ID may be a middle value (e.g., 5 years old) in the first age range (e.g., 4 to 6 years olds), and the user or the system 100 can define the length of the first age range; similarly, the gestational age associated with the parent ID may be a middle value (e.g., 22 weeks) in the second age range (e.g., 18 to 26 weeks), and the user or the system 100 can define the length of the second age range.

In one embodiment, the personal basic data further includes a resident region, a user defined language, and so forth. In this way, the information on a recommended parent ID is shown in an electronic map (e.g., a world map) of the social networking website for improving user experience, and the social networking website provides an automatic translation according to the user defined language for internationalization.

Moreover, the social networking website provides a recommended itinerary for a family tour based on the user defined language and the child age, and the recommended itinerary is shown in the electronic map. Thus, the user can share his or her travel experience through the social networking website and browses the recommended itinerary shared by another parents. In practice, the social networking website can be linked to travel sites and/or web-blog.

The user can input a search keyword to the social networking website for finding out another parents having similar background. When the search keyword received through the network device 110 appears in a posted article of the recommended parent ID, the information on the recommended parent ID is provided for the parent ID of the user. Alternatively, when a posted article of the parent ID and another posted article of the recommended parent ID are partially matched, the information on the recommended parent ID is provided for the parent ID of the user.

The social networking website provides a plurality of networking groups (e.g., network family, Internet community or the like) shown in the electronic map; when one of the networking groups is selected by the parent ID, the recommended parent ID is chosen form the one of the networking groups. For example, the user can establish or join in the networking group, and the networking group is on the basis of the common characteristics, such as children interest, collection, pet, sports, language, ethnicity, and so forth.

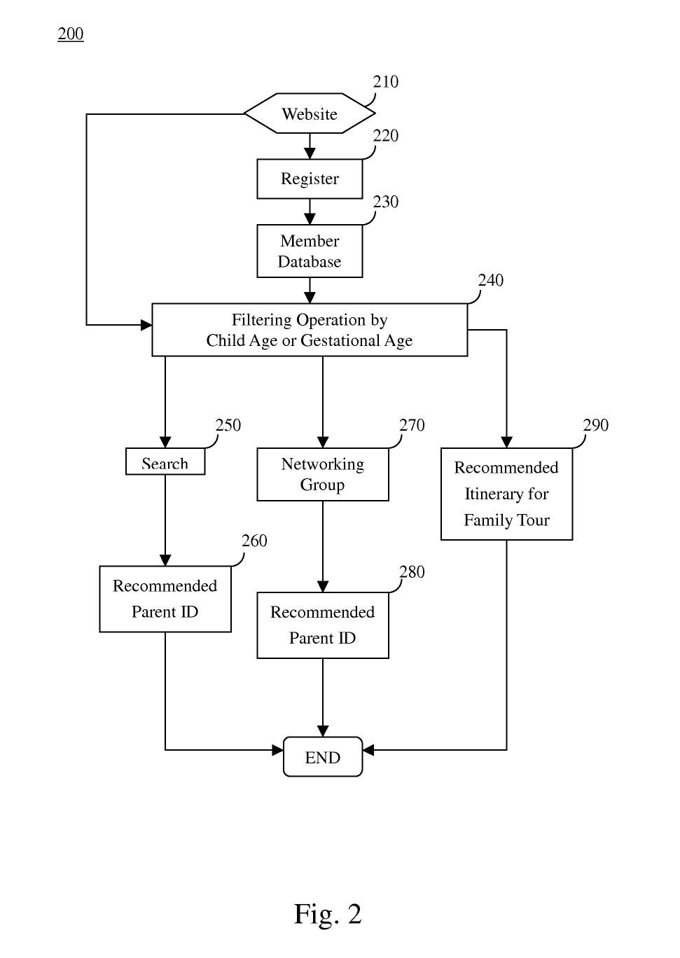

FIG. 2 is a flowchart of a method 200 of providing the social networking website according to another embodiment of the present disclosure. The method 200 can be implemented by a computer, such as the above-mentioned system 100; alternatively, a portion of the function of the method 200 can be implemented as a computer program, and stored in a computer-readable recording medium; the computer program has a plurality of instructions, which when executed in a computer causes the computer to execute the method 200.

As illustrated in FIG. 2, the method 200 includes steps 210-290. However, as could be appreciated by persons having ordinary skill in the art, for the steps described in the present embodiment, the sequence in which these steps is performed, unless explicitly stated otherwise, can be altered depending on actual needs; in certain cases, all or some of these steps can be performed concurrently. As to the hardware devices required for the implementation of these steps, they have been specifically disclosed in the above-mentioned embodiments, and hence will not be repeated hereinbelow.

In step 210, the social networking website is provided for parents. In step 220, a user can register a parent ID, and then the parent ID is stored in the member database of the social networking website in step 230. In the filtering operation of step 240, after the parent ID is received through the network device, a user profile associated with the parent ID is acquired from a member database when the parent ID is logged in the social networking website, where the user profile includes a plurality of personal basic data, the personal basic data at least includes a child age or a gestational age, next a first age range based on the child age or a second age range based on the gestational age is set, and then the member database is searched for a recommended parent ID based on the personal basic data; for example, when the child age associated with the parent ID and another child age associated with another parent ID both fall within the first age range, or when the gestational age associated with the parent ID and another child age associated with said another parent ID both fall within the second age range, said another parent ID is served as the recommended parent ID. In one embodiment, different weight values are set for the personal basic data, and then a weight analysis is performed to find out the recommended parent ID.

The user can input a search keyword to the social networking website for finding out another parents having similar background. In step 250, when the search keyword received through the network device appears in a posted article of the recommended parent ID, the information on the recommended parent ID is provided for the parent ID of the user in step 260; alternatively, when a posted article of the parent ID and another posted article of the recommended parent ID are partially matched, the information on the recommended parent ID is provided for the parent ID of the user in step 260.

In one embodiment, the personal basic data further includes a resident region, a user defined language, and so forth. In step 260, the information on the recommended parent ID is shown in an electronic map (e.g., a world map) of the social networking website for improving user experience. Furthermore, the social networking website provides an automatic translation according to the user defined language for internationalization.

In step 270, the user can establish or join in one or more networking group (e.g., network family, Internet community or the like), and the networking group is on the basis of the common characteristics, such as children interest, collection, pet, sports, language, ethnicity, and so forth. In step 280, the social networking website provides a plurality of networking groups shown in the electronic map; when one of the networking groups is selected by the parent ID, the recommended parent ID is chosen form the one of the networking groups.

In step 290, the social networking website provides a recommended itinerary for a family tour based on the user defined language and the child age, and the recommended itinerary is shown in the electronic map. Thus, the user can share his or her travel experience through the social networking website and browses the recommended itinerary shared by another parents. In practice, the social networking website can be linked to travel sites and/or web-blog.

Although various embodiments of the invention have been described above with a certain degree of particularity, or with reference to one or more individual embodiments, they are not limiting to the scope of the present disclosure. Those with ordinary skill in the art could make numerous alterations to the disclosed embodiments without departing from the spirit or scope of this invention. Accordingly, the protection scope of the present disclosure shall be defined by the accompany claims.

What is claimed is:

1. A system of providing a social networking website, the system comprising:
a network device;
a member database;
a processor; and
a memory coupled to the processor and configured for storing instructions, which, when executed by the processor, performs operations comprising:
receiving a parent identification (ID) through the network device;
acquiring a user profile associated with the parent ID from the member database when the parent ID is logged in the social networking website, wherein the user profile includes a plurality of personal basic data, the personal basic data at least includes a child age or a gestational age; and
determining a first age range based on the child age or a second age range based on the gestational age; and
when the child age associated with the parent ID and another child age associated with another parent ID both fall within the first age range, or when the gestational age associated with the parent ID and another child age associated with said another parent ID both fall within the second age range, serving said another parent ID as a recommended parent ID, and providing information on the recommended parent ID for the parent ID.

2. The system of claim 1, wherein the information on the recommended parent ID is shown in an electronic map of the social networking website.

3. The system of claim 1, wherein the personal basic data further comprises a resident region and a user defined language.

4. The system of claim 3, wherein the social networking website provides an automatic translation according to the user defined language.

5. The system of claim 3, wherein the operations further comprises:
searching the member database for the recommended parent ID based on the personal basic data.

6. The system of claim 3, wherein the social networking website provides a recommended itinerary for a family tour based on the user defined language and the child age.

7. The system of claim 6, wherein the recommended itinerary is shown in an electronic map.

8. The system of claim 1, wherein the information on the recommended parent ID is provided when a search keyword received through the network device appears in a posted article of the recommended parent ID.

9. The system of claim 1, wherein the information on the recommended parent ID is provided when a posted article of the parent ID and another posted article of the recommended parent ID are partially matched.

10. The system of claim 1, wherein the social networking website provides a plurality of networking groups shown in an electronic map, and when one of the networking groups is selected by the parent ID, the recommended parent ID is chosen form the one of the networking groups.

11. A method of providing a social networking website, the method comprising:
receiving a parent ID through a network device;
acquiring a user profile associated with the parent ID from a member database when the parent ID is logged in the social networking website, wherein the user profile includes a plurality of personal basic data, the personal basic data at least includes a child age or a gestational age; and
determining a first age range based on the child age or a second age range based on the gestational age; and
when the child age associated with the parent ID and another child age associated with another parent ID both fall within the first age range, or when the gestational age associated with the parent ID and another child age associated with said another parent ID both fall within the second age range, serving said another parent ID as a recommended parent ID, and providing information on the recommended parent ID for the parent ID.

12. The method of claim 11, wherein the information on the recommended parent ID is shown in an electronic map of the social networking website.

13. The method of claim 11, wherein the personal basic data further comprises a resident region and a user defined language.

14. The method of claim 13, wherein the social networking website provides an automatic translation according to the user defined language.

15. The method of claim 13, further comprising:
searching the member database for the recommended parent ID based on the personal basic data.

16. The method of claim 13, wherein the social networking website provides a recommended itinerary for a family tour based on the user defined language and the child age.

17. The method of claim 16, wherein the recommended itinerary is shown in an electronic map.

18. The method of claim 11, wherein the information on the recommended parent ID is provided when a search keyword received through the network device appears in a posted article of the recommended parent ID.

19. The method of claim 11, wherein the information on the recommended parent ID is provided when a posted article of the parent ID and another posted article of the recommended parent ID are partially matched.

20. The method of claim 11, wherein the social networking website provides a plurality of networking groups shown in an electronic map, and when one of the networking groups is selected by the parent ID, the recommended parent ID is chosen form the one of the networking groups.
